(19) United States
(12) Patent Application Publication
(10) Pub. No.: US 2003/0033834 A1
(43) Pub. Date: Feb. 20, 2003

(54) Method of depositing a cladding layer

(76) Inventor: Michael Bazylenko, Eveleigh (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/932,238

(22) Filed: Aug. 17, 2001

(51) Int. Cl. C03B 37/022

(52) U.S. Cl. 65/386

(57) ABSTRACT

The present invention provides a method of depositing a cladding layer over external surfaces of a waveguide structure formed on a planar substrate, the waveguide structure comprising a planar waveguide core formed on the planar substrate and a raised structure formed on the planar substrate adjacent the waveguide core. The invention allows high-aspect-ratio gaps in a planar optical waveguide structure to be filled without incorporating macroscopic or microscopic voids. In one embodiment, the method comprises depositing a cladding material over the planar waveguide structure, etching the deposited cladding material so as to reduce shadowing effects between the waveguide core and the raised structure during the deposition of the cladding material, and controlling at least one parameter of the deposition so as to form a cladding layer front the deposited material. In another embodiment, the method involves modifying the profile of the waveguide structure before depositing the cladding layer.

### FIELD OF THE INVENTION

The present invention relates broadly to a method of depositing a cladding layer over at least one planar waveguide core formed on a planar substrate. The present invention also extends to waveguide device structures formed utilising the method, or incorporating components formed utilising the method.

### BACKGROUND OF THE INVENTION

The fabrication of a planar optical waveguide on a planar substrate involves encapsulating a thin film waveguide core in an outer layer of lower refractive index thin film material for optically isolating the core. The outer layer usually comprises a buffer layer on which the core is formed, and a cladding layer which overlays the core and buffer layer. The cladding and buffer layers often comprise silica or silica-based materials and ideally have the same refractive index. The buffer layer is commonly formed on the substrate by plasma-enhanced chemical vapour deposition (PECVD) or by thermal oxidation of silicon. The waveguide core is then formed directly on the buffer layer, typically by photolithographically-defined etching of a silica-based film. Where the waveguide is in the form of a channel waveguide, the core normally has a square or rectangular cross-sectional shape, or alternatively, a trapezoidal cross-sectional shape in which the waveguide has sidewalls which are non-perpendicular to the substrate. The cladding layer is then deposited over the core and the buffer layer, often also by PECVD.

As the complexity of planar waveguide devices increases it is becoming increasingly necessary to reduce the distance or gap between adjacent structures, such as waveguide cores, on a substrate. For example, the gap between adjacent waveguide cores can be of a width comparable to or smaller than the heights of the waveguide cores. When the cladding layer is formed by PECVD, material is typically deposited from a range of directions. If the heights of the waveguide cores are comparable to the gap between the cores, the cores tend to cast shadows over the gap and give rise to the deposition of a cladding layer which has a non-uniform thickness. Within the gap, the cladding layer tends to be thickest near the top of the core. As the cladding layer grows in thickness, it gradually forms a structure which overhangs the gap and in turn enhances the shadowing effect. Eventually, the overhanging regions of the cladding layer join together, forming an air bubble between the buffer layer and overhanging material. The presence of such an air bubble is undesirable for a number of reasons, including its influence on the optical properties of the cladding layer and the possibility of trapping moisture in the air bubble or accumulating moisture in the air bubble through openings in the cladding layer.

In order to prevent the formation of such an air bubble, it is known to deposit the cladding layer in stages and to periodically reflow the cladding layer material at temperatures above the cladding material melting point, typically above 1000° C., in order to control the formation of overhanging material. However, there are many situations in which it is particularly undesirable to heat a waveguide structure to such high temperatures, such as when the waveguide is integrated with microelectronic devices.

It is noted here that the shadowing effect described above is not limited to particular PECVD techniques. Rather, the shadowing effect can be encountered in any gas or vacuum-phase deposition technique, albeit lo different degrees.

At least preferred embodiments of the present invention seek to provide an alternative method for depositing a cladding layer over adjacent planar waveguide cores which can avoid the formation of an air bubble between the waveguide cores.

### SUMMARY OF THE INVENTION

In accordance with a first aspect of the present invention there is provided a method of depositing a cladding layer over external surfaces of a waveguide structure formed on a planar substrate, the waveguide structure comprising a planar waveguide core formed on the planar substrate and a raised structure formed on the planar substrate adjacent the waveguide core, the method comprising the steps of depositing a cladding material over the waveguide structure, etching the deposited cladding material so as to reduce shadowing effects between the waveguide core and the raised structure during the deposition of the cladding material, and controlling at least one parameter of the deposition so as to form a cladding layer from the deposited material.

Preferably, the cladding material is deposited and etched such that the resultant cladding layer is substantially free of macroscopic and microscopic voids.

The raised structure may comprise one in a group comprising a further planar waveguide core, a slab waveguide, a contact structure, a support structure, a processor structure, and an alignment structure.

The step of etching preferably comprises preferentially etching the cladding material at or near corners of the waveguide core and raised structure.

The step of etching is preferably conducted in a manner which reduces shadowing effects resulting from an accumulation of deposited cladding material at or near respective opposed corners of the waveguide core and raised structure. Advantageously, the step of etching is conducted in a manner which reduces shadowing effects by removing overhanging structures extending from corners of the waveguide core and raised structure, the overhanging structures resulting from a build-up of cladding material. The corners may have a rounded profile.

A rate of the etching may be increased with increasing heights of the waveguide core and/or the raised structure.

The step of etching may comprise ion bombarding the deposited cladding material so as to cause sputtering. The ions involved in the ion bombardment may comprise argon (Ar) ions or ions of another noble gas and are preferably directed at an angle of substantially 90° to the substrate.

The step of etching may be conducted simultaneously with the step of depositing the cladding material. Alternatively, the step of etching and the step of depositing the cladding material may be conducted sequentially.

The step of etching may be conducted in a manner which controls the energy of cladding material which is etched away but subsequently re-deposited in the region between the waveguide core and the raised structure, whereby to control a material property of the material deposited in the region between the waveguide core and the raised structure.

The cladding material may comprise a silica-based material. Where the cladding material is silica-based, the step of depositing the cladding material preferably comprises PECVD. The PECVD may be conducted in the absence of nitrogen or nitrogen-containing gases.

The PECVD process may be conducted such that the etching results from ion bombardment arising from the PECVD process. The ion bombardment arising from the PECVD may be controlled by controlling one or more deposition parameters in a group comprising: power input into the PECVD; frequency of a radio frequency (RF) power supply for the PECVD; power of one power supply in a dual-frequency power supply for the PECVD; substrate temperature; and argon-to-precursor vapour ratio during the PECVD.

The PECVD process may comprise utilising a liquid source for the precursor vapour.

The step of depositing the cladding material may comprise depositing a gap-fill layer of the cladding material to substantially fill a gap between the waveguide core and the raised structure and depositing an overlayer of cladding material over the gap-fill layer, the overlayer being deposited at a higher deposition rate than the gap-fill layer. The method may further comprise a step of annealing the deposited cladding material to equalise the densities of cladding material deposited between the waveguide core and the raised structure and above the waveguide core.

The method may further comprise a step of doping the cladding layer with a refractive-index-modifying dopant during or after the deposition of the cladding material.

The step of depositing cladding material may comprise depositing a plurality of layers of cladding material, wherein at least one of the layers exhibits a compressive stress and the remaining layer(s) exhibits a tensile stress which at least partially compensates for the compressive stress. Preferably, the cladding layer has substantially zero net stress.

Where the etching results from ion bombardment during the PECVD, the cladding layer may be formed with a predetermined stress by controlling the etching component during the deposition of the cladding material.

The etching may be conducted in a manner which prevents etching of the waveguide structure.

Alternatively, the etching may further comprise etching the waveguide structure at or near opposing corners of the waveguide core and raised structure.

Where the etching and deposition occur sequentially, the steps of depositing and etching the cladding material may be conducted in respective dedicated processing chambers.

The substrate may comprise an optical buffer layer formed on an underlying substrate wafer, for optically isolating the waveguide core from the substrate wafer.

An aspect ratio (ratio of depth to width) of a region between the waveguide core and the raised structure may be at least 0.5:1. In one embodiment, the aspect ratio is at least 0.8:1.

In accordance with a second aspect of the present invention there is provided a method of depositing a cladding layer over a waveguide structure formed on a planar substrate, the waveguide structure comprising a planar waveguide core formed on the planar substrate and a raised structure formed on the planar substrate adjacent the waveguide core, the method comprising the steps of modifying cross-sectional shapes of the waveguide core and the raised structure, depositing a cladding material over external surfaces of the modified waveguide core and raised structure, and controlling at least one parameter of the deposition so as to form a cladding layer from the deposited cladding material, wherein the cross-sectional shapes are modified such that there is a reduction in shadowing effects between the waveguide core and the raised structure during the deposition of the cladding material.

Preferably, the waveguide core and the raised structure are modified such that the resultant cladding layer is substantially free of macroscopic and microscopic voids.

The raised structure may comprise one in a group comprising a further planar waveguide core, a slab waveguide structure, a contact structure, a support structure, a processor structure, and an alignment structure.

The waveguide core and the raised structure may be modified such that at least portions of sidewalls of the modified waveguide core and raised structure are sloped with respect to the substrate. The modified waveguide core may have a generally-triangular cross-sectional shape. In such an embodiment, the resulting sloped sidewalls of the modified waveguide core can be smoother than the original sidewalls of the waveguide core, thereby reducing optical scattering losses in the waveguide core.

The step of modifying the cross-sectional shapes may comprise preferentially etching the waveguide core and the raised structure at or near respective opposed corners of the waveguide core and the raised structure.

The sputtering may be a result of ion bombardment, such as with argon ions. Preferably the ions involved in the ion bombardment are directed at an angle of substantially 90° to the substrate.

The substrate may comprise an optical buffer layer formed on an underlying substrate wafer for optically isolating the waveguide core from the substrate wafer.

An aspect ratio (ratio of depth to width) of a region between the unmodified waveguide core and raised structure may be at least 0.5:1. In one embodiment, the aspect ratio is at least 0.8:1.

In accordance with a third aspect of the present invention there is provided an optical component fabricated utilising the methods described in either the first or second aspect of the invention.

In accordance with a fourth aspect of the present invention there is provided an optical component assembly incorporating a component fabricated utilising the methods described in either the first or second aspect of the invention.

### BRIEF DESCRIPTION OF THE DRAWINGS

Embodiments of the present invention will now be described, by way of example only, with reference to the accompanying drawings.

FIGS. 1A-C are schematic drawings illustrating an embodiment of a method of depositing a cladding layer over adjacent waveguide cores.

FIG. 2 is a schematic drawing of a fabrication system for implementing a method embodying the present invention.

FIG. 3 is a schematic drawing showing another fabrication system for implementing a method embodying the present invention.

FIGS. 4A-C are schematic diagrams illustrating another embodiment of a method of forming a cladding layer over adjacent waveguide cores.

FIGS. 5A-C are schematic diagrams illustrating another embodiment of a method of forming a cladding layer over adjacent waveguide cores.

### DETAILED DESCRIPTION OF THE EMBODIMENTS

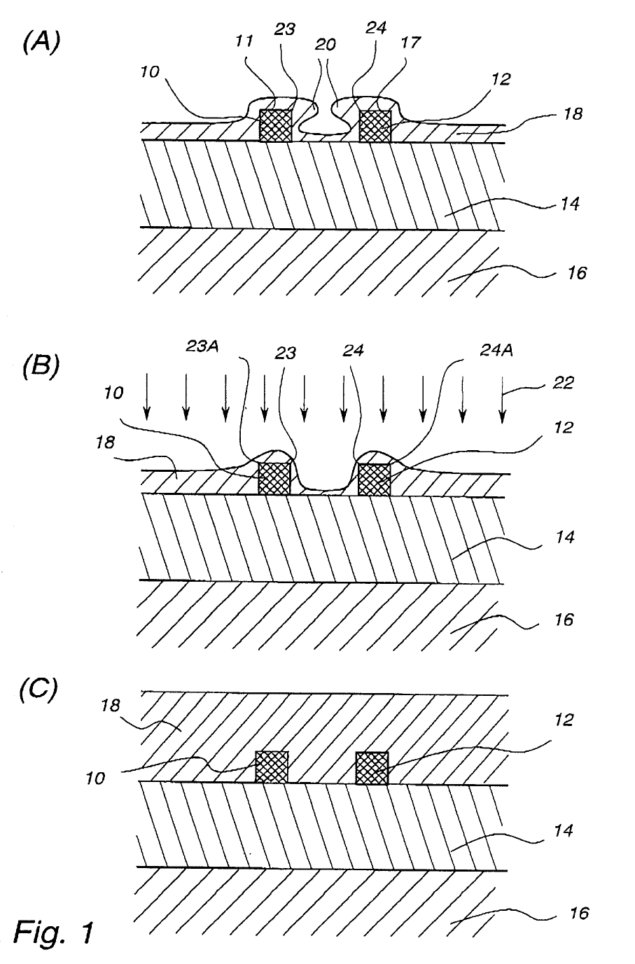

The embodiments described below provide a method of depositing a cladding layer over a waveguide structure comprising a waveguide core and an adjacent raised structure in which the formation of an air bubble between the waveguide core and raised structure is prevented. The method will be described using an example in which the raised structure comprises another waveguide core. However, it will be understood that the raised structure can comprise any physical structure which is disposed closely adjacent to the waveguide core so as to form a gap therebetween. The principles of a method embodying the present invention will initially be described with reference to FIGS. 1A-C.

FIG. 1A shows a waveguide structure in the form of two closely-adjacent waveguide cores 10, 12 formed on a silica buffer layer 14 which is in turn formed on a substrate wafer in the form of a silicon wafer 16. The external surfaces 1 and 17 of the adjacent waveguide cores 10, 12 are coated with a partially-completed silica cladding layer 18. It can be seen in FIG. 1A that the cores 10, 12 are separated by a gap which has an aspect ratio (ratio of core height to gap width) of about 0.5:1. Thus, each core 10, 12 tends to cast a shadow which gives rise to a deposition rate between the cores which increases with height above the buffer layer 14. The deposition rate between the cores 10,12 is therefore lowest near to the buffer layer 14 and highest at opposed corners 23, 24 of the adjacent cores 10, 12. The non-uniform deposition rate between the cores results in the formation of overhanging cladding material 20 at or near the corners 23, 24.

The overhangs 20 enhance the shadowing effect between the waveguide cores 10, 12 and can eventually result in the formation of an air bubble as described in the background section. However, in the method embodying the present invention (illustrated in FIG. 1B), a sputtering step is conducted to remove overhangs 20. In the sputtering step, the entire surface of the partially completed cladding layer 18 is bombarded with argon ions at an angle of 90° to the wafer 16, as indicated by arrows 22. Although the entire layer of cladding material is exposed to the ion bombardment, the cladding material deposited over corners 23, 24, 23A, 24A is sputtered away at a higher rate than cladding material deposited on other surfaces. As a result, the overhangs 20 are etched away so as to allow cladding material to be deposited closer to the buffer layer 14. The reason that cladding material is etched preferentially at the corners 23, 24, 23A, 24A is based on the inventor's realisation that the sputter rate from ion bombardment is at a maximum when ions impact a surface at an angle which is less than 90° and greater than 0°, and typically around 60°. Thus, surfaces perpendicular to the bombarding ions are sputtered at a lower rate than surfaces which are angled towards the ions, such as the corners 23, 24, 23A, 24A.

The removal of overhangs 20 reduces the shadowing between the cores 10, 12 during subsequent depositions of cladding material and allows the gap to be filled without including air bubbles, as is shown in FIG. 1C.

It will be appreciated by a person skilled in the art that the principles described above with reference to FIGS. 1A-C are equally applicable to other methods of depositing cladding layers over adjacent waveguide cores, such as where the deposition and sputtering occur simultaneously during one processing step.

Furthermore, it is noted that during the removal of overhangs 20 shown in FIG. 1B, a portion of the material sputtered away due to ion bombardment is re-deposited in the gap between the waveguide cores 10, 12. The energy of the re-deposited particles can be controlled through appropriate control of the ion bombardment energy. The resultant physical properties of the cladding material between the waveguide cores 10, 12 can thus be controlled to, for example, differ from those of the cladding material deposited at or near the top of the waveguide cores 10, 12. Accordingly, the refractive index may be adjusted to achieve a desirable effect.

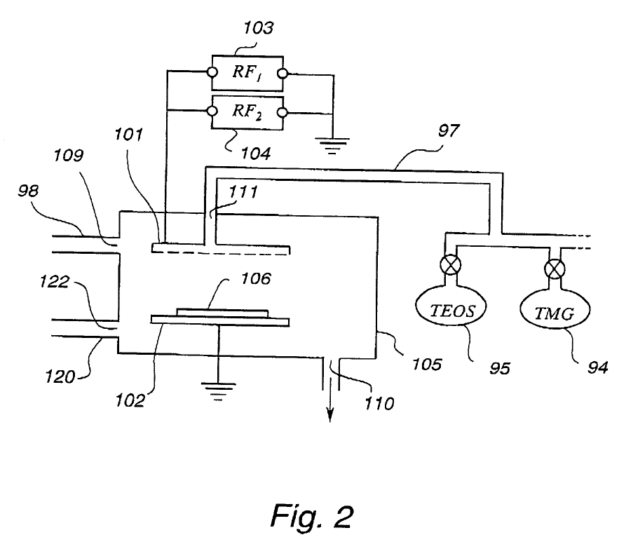

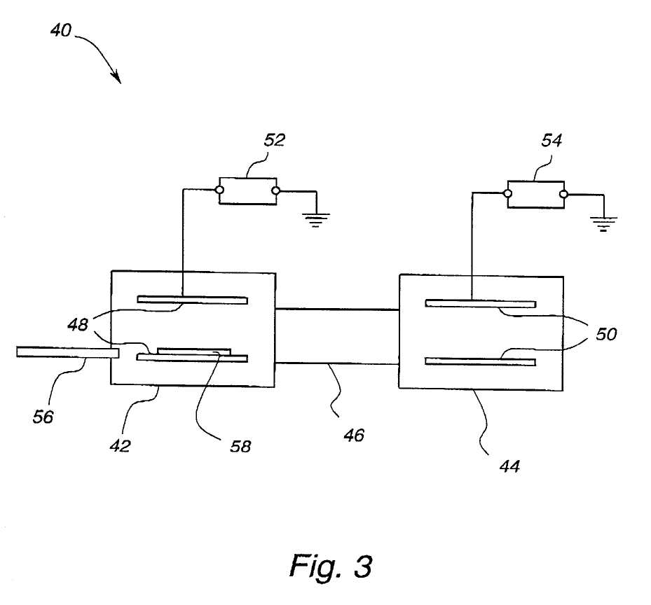

Two alternative cladding layer fabrication systems will now be described with reference to FIGS. 2 and 3.

Turning initially to FIG. 2, a PECVD chamber 105 is shown in which two opposing electrodes 101, 102 which form a circuit with a series of RF power supplies 103, 104. As in conventional PECVD chambers, an RF plasma discharge is generated between the two electrodes 101, 102 in the presence of a precursor vapour during the deposition of a silica-based cladding layer over adjacent waveguide cores (as shown in FIG. 1A) located on a substrate wafer 106.

A pump port 110 leading to a vacuum pump (not shown) is provided for evacuating the PECVD chamber 105. The substrate wafer 106 is supported on the bottom electrode 102.

Oxygen is delivered in gas-feed pipe 98 and introduced in the PECVD chamber 105 through port 109 in a sidewall of the PECVD chamber 105. Another gas-feed pipe 120 and port 122 are provided for the introduction of argon into the PECVD chamber 105. A further port 111 is utilised to introduce a precursor vapour into a shower-head electrode 101 from a precursor-feed pipe 97 connected to a vessel 95, which in the example embodiment contains liquid tetraethoxysilane (TEOS) for the PECVD of the silica-based cladding layer.

It will be appreciated by the person skilled in art that provisions for valves are made in the feed pipes 97, 98 and 120 but those are not illustrated for simplicity.

In the example embodiment, a further vessel 94 is connected to the precursor-feed pipe 97, the vessel 94 containing tetramethylgermanium (TMG). TMG can be utilised as a dopant precursor during the deposition of the silica-based cladding layer from the TEOS liquid source for controlling optical properties in the resultant cladding layer.

It will be understood that precursors other than TEOS and/or dopant precursors other than TMG can be used to form the cladding layer.

Of the two RF power supplies 103, 104, a first RF power supply 103 operates at a frequency of 13.56 MHz, and a second RF power supply 104 operates at a lower frequency of 450 kHz.

A substrate heating apparatus (not shown) is provided for heating the substrate wafer 106 during the deposition to temperatures of the order of 350° C. so as to form a silica-based cladding layer from the TEOS and TMG precursors. The substrate heating apparatus is not shown here for simplicity. Also, the person skilled in the art will understand that the RF circuitry is shown in FIG. 2 in a simplified form. For example, an impedance matching circuit would normally be used with each power supply 103, 104 but is not illustrated here for simplicity. Any one of a number of commercially-available RF power supplies may be used in the present invention. The RF power supplies 103, 104 can be connected in a number of different ways without departing from the spirit or scope of the present invention.

During the PECVD deposition of a cladding layer, simultaneous ion bombardment of the film being deposited can be enhanced by introducing argon or another noble gas into the PECVD chamber 105 through port 122. Due to the geometry of the electrodes 101, 102, the argon ions impact on the substrate 106 at an angle of substantially 90°. The flux and energy of ion bombardment is selected to be sufficient to preferentially sputter surfaces which are sloped relative to the direction of ion bombardment (as shown in FIG. 1B).

The degree of ion bombardment can be controlled by adjusting one or more of the following deposition parameters:

(a) The power input into the PECVD;

(b) The frequency of the 450 kHz RF power supply for the PECVD;

(c) The power of the 450 kHz power supply;

(d) The substrate temperature; and

(e) The argon-to-precursor vapour flow ratio during the PECVD.

Furthermore, at least one deposition parameter is controlled such that the deposited material is capable of functioning as an optical cladding layer, i.e. suitable thickness, refractive index-profile, optical transparency etc. The at least one parameter can include any one of the above listed parameters and others, such as concentration and type of dopant. Preferably, the optical properties of the cladding layer are controlled to match those of a buffer layer on which the waveguide cores are formed. The deposition parameters are preferably controlled so as to produce a cladding layer which has zero net stress. The stress in films deposited by PECVD may be made more tensile (less compressive) by increasing the deposition rate. Also, the film stress may be made more tensile stress by decreasing the average ion bombardment energy during the deposition. Thus, in general, the stress in the cladding layer can be made more tensile by increasing the ratio of deposition rate to average ion bombardment energy. The cladding layer can comprise multiple layers arranged one above the other and can be deposited in stages. For example, a gap-fill layer of cladding material can be deposited between the cores at a low deposition rate which gives rise to compressive stress, and an overlayer of cladding material can be deposited over the gal)-fill layer at a higher deposition rate which gives rise to a tensile stress. By controlling the stress and thickness of the gap-fill layer and the overlayer, the net stress in the cladding layer can be substantially cancelled. Further information about controlling cladding layer stress during PECVD are disclosed in pending U.S. provisional patent application No. 60/290,374 entitled “Silica-based optical device fabrication” filed in the name of Michael Bazylenko (assigned to Redfern Integrated Optics Pty Ltd), the disclosure of which is hereby specifically incorporated by cross-reference.

Turning now to FIG. 3, another fabrication system 40 embodying the present invention comprises a dedicated deposition chamber 42 and a dedicated sputtering chamber 44 connected via a transfer chamber 46.

It will be appreciated by the person skilled in the art that the deposition chamber 42, the sputtering chamber 44 and the transfer chamber 46 are provided with suitable evacuation means known in the art to effect vacuum transfer between different vacuum chambers. Those evacuation means have been omitted from FIG. 3 for simplicity.

The deposition chamber 42 and the sputtering chamber 44 comprise pairs of electrodes 48, 50 respectively, which are connected to RF power supplies 52, 54 respectively. Again, an RF plasma discharge is generated between the respective pairs of electrodes 48, 50 to either deposit the cladding layer in the presence of a cladding material precursor (deposition chamber 42) or to sputter in an argon/oxygen atmosphere (sputtering chamber 44).

A transfer robot arm 56 is provided at the fabrication system 40 for effecting transfer of a wafer substrate 58 between the deposition chamber 42 and the sputtering chamber 44. Again, it will be appreciated that suitable evacuation mean±s are provided in conjunction with the robot arm 56 such as a differential pumping system, but those have been omitted for simplicity.

When utilising a fabrication system of the type shown in FIG. 3 with dedicated and separate deposition and sputtering chambers 42, 44, it may be preferable to reduce the number of sequential deposition and sputtering steps in order to reduce the number of times the substrate 58 is transferred between chambers 42,44, thereby increasing the efficiency of the overall deposition process.

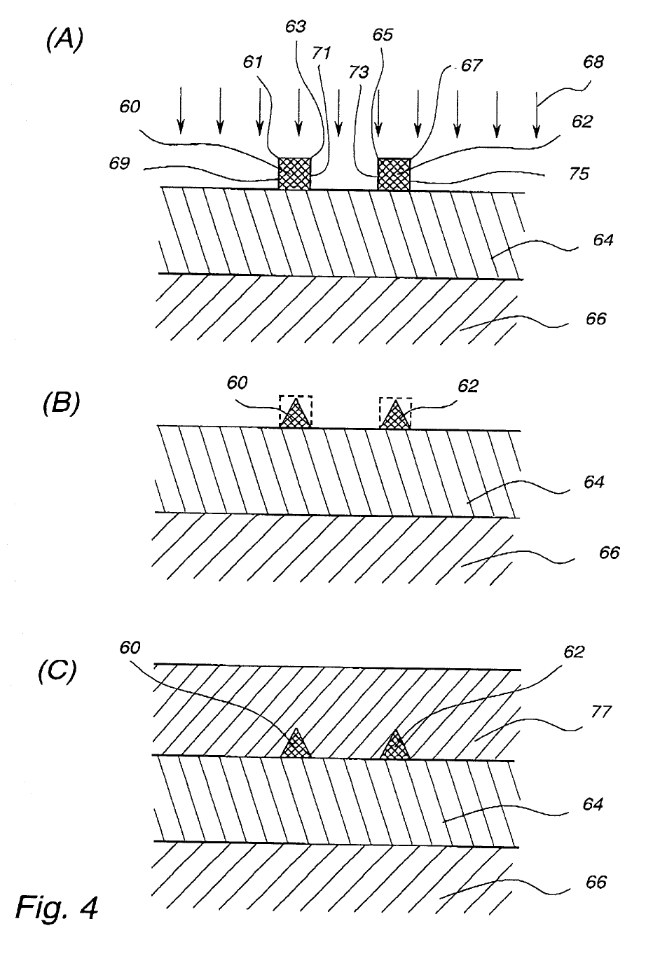

In FIGS. 4A-C, the principles of an alternative method of depositing a cladding layer over two closely-adjacent waveguide cores will now be described. In a first step, shown in FIG. 4A, waveguide cores 60, 62 formed on a buffer layer 64 which is in turn formed on a silicon wafer 66 are sputtered by ion bombardment in a direction perpendicular to the wafer 66 as indicated by arrows 68.

As there is no cladding layer present at this stage, the sputtering will preferentially remove material from all external surfaces of the waveguide cores 60, 62. However, upper regions of the cores around upper corners 61, 63, 65, 67 of the original sidewalls 69, 71, 73, 75 are sputtered preferentially i.e. at a higher sputter rate than other surfaces of the cores 60, 62. Thus sputtering results in the shapes of the waveguide cores 60, 62 being modified such that upper corners 61, 63, 65, 67 form surfaces which are sloped with respect to the wafer 66. In the example embodiment shown in FIG. 4B, the sputtering step has been continued until the original sidewalls are sloped relative to the wafer 66 and the modified waveguide cores 60, 62 have a generally-triangular cross-sectional shape. The outline of the original core profile prior to etching is shown in dashed lines.

The inventor has found that shadowing effects during the deposition of a cladding layer over the modified core shaped shown in FIG. 1B are substantially eliminated, thus enabling a cladding layer 77 (see FIG. 4C) to be deposited in a single stage without forming an air bubble between the waveguide cores 60, 62.

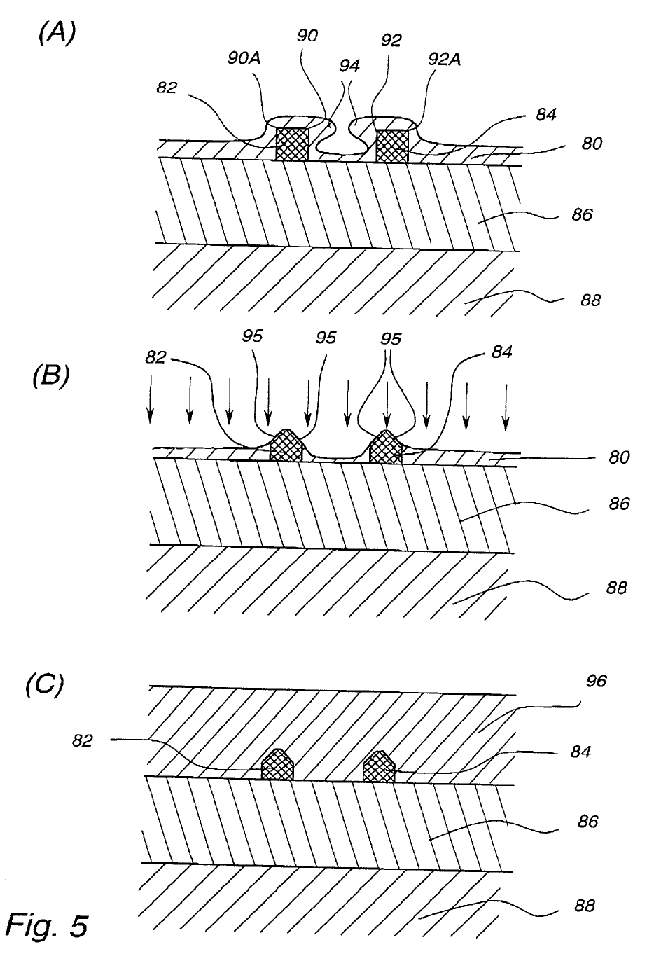

Referring to FIGS. 5A-C, the principles of a further method of depositing a cladding layer over two closely-adjacent waveguide cores will now be described. In a first step, shown in FIG. 5A, a partial cladding layer 80 is initially deposited over closely-adjacent waveguide cores 82, 84 formed on a buffer layer 86 which is in turn formed on a silicon wafer 88. Again, there is an accumulation of cladding material at respective opposed corners 90, 92 of the respective adjacent cores 82, 84, which results in the formation of overhanging cladding material 94 at or near the corners 90, 92.

In a second step shown in FIG. 5B, ion bombardment using argon ions or ions of other noble gases at an angle of 90° to the wafer 88 is conducted in a similar manner to the embodiment described above in relation to FIGS. 1A-C. However, in this embodiment (FIG. 5B) the sputtering step is conducted to remove not only the overhangs 94, but is continued to remove material from the corners 90, 92, 90A, 92A of the waveguides 82, 84. As a result, upper regions 95 of the original sidewalls of the waveguides 82, 84 become sloped relative to the wafer 88.

The inventor has found that shadowing effects are substantially eliminated during the subsequent deposition of further cladding material over the modified structure shown in FIG. 5B, thus enabling a cladding layer 96 to be deposited without forming an air bubble between the waveguide cores 82, 84, as shown in FIG. 5C. The inventor has further found that this method of depositing part of the cladding layer, etching back (partially into the waveguide cores) and subsequent completion of the cladding layer provides a process suitable for high throughput while reducing the extent to which the cores are modified.

It will be appreciated by the person skilled in the art that numerous modification and/or variations may be made to the present invention as shown in the specific embodiments without departing from the spirit or scope of the invention as broadly described. The present embodiments are, therefore, to be considered in all respects to be illustrative and not restrictive.

For example it will be appreciated that deposition and/or etching techniques other than those described in relation to the above embodiments may be used without departing from the spirit or scope of the present invention, including but not limited to, sputter deposition techniques for the deposition step, and/or ion gun sputtering techniques for the etching step, and/or chemical etching techniques for the etching step.

Furthermore, the present invention is not limited to forming a cladding layer over two adjacent waveguide cores. Rather, the present invention can be extended to the formation of a cladding layer over a waveguide structure including a waveguide core on a planar substrate and a raised structure formed on the planar substrate adjacent the waveguide core. The raised structure may comprise one in a group comprising a contact structure, a slab waveguide, a support structure, a processor structure, an alignment structure, or a further planar waveguide core.

In the claims that follow and in the summary of the invention, except where the context requires otherwise due to express language or necessary implication the word “comprising” is used in the sense of “including”, i.e. the features specified may be associated with further features in various embodiments of the invention.

We claim:

1. a method of depositing a cladding layer over external surfaces of a waveguide structure formed on a planar substrate, the waveguide structure comprising a planar waveguide core formed on the planar substrate and a raised structure formed on the planar substrate adjacent the waveguide core, the method comprising the steps of:
depositing a cladding material over the planar waveguide structure,
etching the deposited cladding material so as to reduce shadowing effects between the waveguide core and the raised structure during the deposition of the cladding material, and
controlling at least one parameter of the deposition so as to form a cladding layer from the deposited material.

2. A method as claimed in claim 1, wherein the cladding material is deposited and etched such that the resultant cladding layer is substantially free of macroscopic and microscopic voids.

3. A method as claimed in claim 1, wherein the raised structure comprises one in a group comprising a further planar waveguide core, a slab waveguide, a contact structure, a support structure, a processor structure, and an alignment structure.

4. A method as claimed in claim 1, wherein the step of etching comprises preferentially etching the deposited material at or near corners of the waveguide structure.

5. A method as claimed in claim 1, wherein the step of etching is conducted in a manner which reduces shadowing effects resulting from an accumulation of cladding material at or near respective opposed corners of the waveguide core and raised structure.

6. A method as claimed in claim 5, wherein the step of etching is conducted in a manner which reduces shadowing effects by removing overhanging structures extending from the corners of the waveguide core and raised structure, the overhanging structures resulting from a build-up of cladding material.

7. A method as claimed in claim 1, further comprising increasing a rate of the etching with increasing height of the waveguide core and/or the raised structure.

8. A method as claimed in claim 1, wherein the step of etching comprises ion bombarding the deposited cladding material so as to cause sputtering.

9. A method as claimed in claim 8, wherein the ions involved in the ion bombardment comprise argon (Ar) ions.

10. A method as claimed in claim 9, wherein the Ar ions are directed at an angle of substantially 90° to the substrate.

11. A method as claimed in claim 1, wherein the step of etching and the step of depositing the cladding material are conducted simultaneously.

12. A method as claimed in claim 1, wherein the step of etching and the step of depositing the cladding material are conducted sequentially.

13. A method as claimed in claim 1, wherein the step of etching is conducted in a manner which controls the energy of any cladding material which is etched away but subsequently re-deposited in the region between the waveguide core and the raised structure, whereby a material property of the material deposited in the region between the waveguide core and the raised structure is controlled.

14. A method as claimed in claim 1, wherein the step of depositing the cladding material comprises PECVD.

15. A method as claimed in claim 14, wherein the PECVD is conducted in the absence of nitrogen or nitrogen-containing gases, whereby optical absorption in the resulting cladding layer is reduced.

16. A method as claimed in claims 14, wherein the PECVD process is conducted such that the etching results from ion bombardment arising from the PECVD process.

17. A method as claimed in claim 14, wherein the PECVD process is conducted such that the etching results from ion bombardment arising from the PECVD process, and wherein the ion bombardment is controlled by controlling one or more deposition parameters in a group comprising: power input into the PECVD, frequency of a radio frequency (RF) power supply for the PECVD; power of one power supply in a dual-frequency power supply for the PECVD; substrate temperature; and argon-to-precursor vapour flow ratio during the PECVD.

18. A method as claimed in claim 14, wherein the PECVD process comprises utilising a liquid source for the precursor vapour.

19. A method as claimed in claim 1, wherein the step of depositing cladding material comprises depositing a gap-fill layer of the cladding material to substantially fill a gap between the waveguide core and the raised structure, and depositing an overlayer of cladding material over the gap-fill layer, the overlayer being deposited at a higher deposition rate than the gap-fill layer.

20. A method as claimed in claim 19, wherein the method further comprises a step of annealing the deposited cladding material to equalise the densities of cladding material deposited between the waveguide core and the raised structure and above the waveguide core.

21. A method as claimed in claim 1, wherein the method further comprises a step of doping the cladding layer with a refractive-index-modifying dopant during or after the deposition of the cladding material.

22. A method as claimed in claim 1, wherein the step of depositing cladding material comprises depositing a plurality of layers of cladding material, wherein at least one of the layers exhibits a compressive stress and the remaining layer(s) exhibits a tensile stress which at least partially compensates for the compressive stress.

23. A method as claimed in claim 22, wherein the cladding layer has substantially zero net stress.

24. A method as claimed in claim 11, wherein the cladding layer is formed with a predetermined stress by controlling the etching component during the deposition of the cladding material.

25. A method as claimed in claim 1, wherein the etching is conducted in a manner which prevents etching of the waveguide structure.

26. A method as claimed in claim 1, wherein the step of etching comprises etching portions of the waveguide structure at or near respective opposed corners of the waveguide core and raised structure.

27. A method as claimed in claim 1, wherein the steps of depositing and etching the cladding material are conducted in respective dedicated processing chambers.

28. A method as claimed in claim 1, wherein the substrate comprises an optical buffer layer formed on an underlying substrate wafer, for optically isolating the waveguide core from the substrate wafer.

29. A method as claimed in claim 1, wherein an aspect ratio of a region between the waveguide core and the raised structure is at least 0.5:1.

30. A method as claimed in claim 29, wherein the aspect ratio is at least 0.8:1.

31. A method of depositing a cladding layer over a waveguide structures formed on a planar substrate, the waveguide structure comprising a planar waveguide core formed on the planar substrate and a raised structure formed on the planar substrate adjacent the waveguide core, the method comprising the steps of:
modifying cross-sectional shapes of the waveguide core and the raised structure,
depositing a cladding material over external surfaces of the modified waveguide core and raised structure, and
controlling at least one parameter of the deposition so as to form a cladding layer from the deposited cladding material,
wherein the cross-sectional shapes are modified such that there is a reduction in shadowing effects between the waveguide core and the raised structure during the deposition of the cladding material.

32. A method as claimed in claim 31, wherein the raised structure comprises one in a group comprising a further planar waveguide core, a slab waveguide, a contact structure, a support structure, a processor structure, and an alignment structure.

33. A method as claimed in claim 31, wherein the waveguide core and the raised structure are modified such that the resultant cladding layer is substantially free of macroscopic and microscopic voids.

34. A method as claimed in claim 31, wherein the waveguide core and the raised structure are modified such that at least portions of sidewalls of the modified waveguide core and the raised structure are sloped with respect to the substrate.

35. A method as claimed in claim 31, wherein the modified waveguide core has a generally-triangular cross-sectional shape.

36. A method as claimed in claim 31. wherein the step of modifying the cross-sectional shapes comprises preferentially etching the waveguide core and the raised structure at or near respective opposed corners of the waveguide core and the raised structure.

37. A method as claimed in claim 36, wherein the preferential etching is a result of ion bombardment.

38. A method as claimed in claim 36, wherein the preferential etching is a result of ion bombardment, and wherein the ions involved in the ion bombardment are directed at an angle of substantially 90° to the substrate.

39. A method as claimed in claim 31, wherein the substrate comprises an optical buffer layer formed on an underlying substrate wafer for optically isolating the waveguide core from the substrate wafer.

40. A method as claimed in claim 31, wherein an aspect ratio of a region between the original waveguide core and raised structure is at least 0.5:1.

41. A method as claimed in claim 31, wherein an aspect ratio of a region between the original waveguide core and raised structure is aL least 0.8:1.

42. An optical component fabricated utilising a method as claimed in either claim 1 or claim 31.

43. An optical component assembly incorporating a component fabricated utilising a method as claimed in either claim 1 or claim 31.
